(19) United States
(12) Patent Application Publication
(10) Pub. No.: US 2009/0088954 A1
(43) Pub. Date: Apr. 2, 2009

(54) APPARATUS FOR AND METHOD OF CONTROLLING VARIABLE VALVE MECHANISM

(75) Inventor: Kenichi MACHIDA, Isesaki-shi (JP)

Correspondence Address: CROWELL & MORING LLP;INTELLECTUAL PROPERTY GROUP, P.O. BOX 14300, WASHINGTON, DC, 20044-4300, US

(73) Assignee: HITACHI, LTD., Tokyo (JP)

(21) Appl. No.: 12/200,343

(22) Filed: Aug. 28, 2008

(30) Foreign Application Priority Data
Sep. 27, 2007 (JP) 2007-251259

(51) Int. Cl. F02D 41/00

(52) U.S. Cl. 701/105

(57) ABSTRACT

An apparatus for and method of controlling a variable valve mechanism capable of continuously varying an effective opening of an intake valve by driving of an actuator, and also, is provided with a default mechanism which mechanically holds the intake valve at a default opening set to be larger than a minimum effective opening when the driving of the actuator is stopped, while the intake valve is being held at the default opening by the default mechanism, the effective opening of the intake valve is detected, the default opening is detected based on the detected effective opening to thereby learning the default opening, so that a direction of supply of a driving force by the actuator is switched between an increase-direction causing an increase in the effective opening and a decrease-direction causing a decrease therein, from the detected or learned default opening.

### BACKGROUND OF THE INVENTION

1. Field of the Invention

The present invention relates to an apparatus for and a method of controlling a variable valve mechanism for continuously varying an effective opening of an engine valve, namely, an effective opening degree in an operating angle and/or a valve lift amount of the engine valve which includes an intake valve and an exhaust valve of the engine.

2. Description of the Related Art

Japanese Laid-open (Kokai) Patent Application Publication No. 2004-76621 discloses, as a variable valve mechanism for continuously varying the effective opening of an engine valve, a variable valve mechanism such that a default mechanism is incorporated therein, which is configured to allow the engine valve to have a minimum effective opening thereof which is small enough for enabling it to control an intake air amount in a minimum intake air amount region, while mechanically holds the engine valve at a default opening that is larger than the minimum effective opening, in order to ensure the starting performance at a time of starting of an engine operation, in particular, at a starting time of the engine operation under a condition where failure of the variable valve mechanism has unfavorably occurred.

However, according to the variable valve mechanism provided with the default mechanism as described above, since a configuration is adopted in which the default opening is determined based on a position at which spring members, namely, mechanical members incorporated in the variable valve mechanism are balanced, a default position might be unavoidably varied from an intended position due to a variation in the elastic characteristics of the spring members or degradation of the same characteristics with time elapsing thereof, and as a result, the starting performance or the controlling performance after the time of starting of the engine operation cannot be maintained favorably.

### SUMMARY OF THE INVENTION

In view of the above problems, an object of the present invention is to favorably maintain the starting performance and the controlling performance after the starting time of an engine operation even though a default opening is varied, in a variable valve mechanism incorporating therein a default mechanism.

In order to achieve the above object, according to the present invention, a variable valve mechanism for continuously varying an effective opening of an engine valve by driving of an actuator is provided with a default mechanism which mechanically holds the engine valve at a default opening larger than a minimum effective opening at a time when the driving of the actuator is stopped, in a state where the engine valve is held at the default opening by the default mechanism, the default opening is learned based on the effective opening of the engine valve detected by a valve opening detector.

The other objects and features of this invention will become understood from the following description with reference to the accompanying drawings.

### BRIEF DESCRIPTION OF THE DRAWINGS

FIG. 1 is a schematic view illustrating an internal combustion engine for vehicle according to the present invention.

FIG. 2 is a perspective view illustrating a variable valve mechanism according to the present invention.

FIG. 3 is a schematic diagram viewed from an arrow A of FIG. 2 illustrating valve operations in which A indicates a valve closing operation at a time of controlling of a minimum valve lift amount, and B indicates a valve opening operation at a time of controlling of the minimum valve lift amount according to the present invention.

FIG. 4 is a schematic diagram viewed from the arrow A of FIG. 2 illustrating the valve operations in which A indicates the valve closing operation at a time of controlling of a medium valve lift amount, and B indicates the valve opening operation at a time of controlling of the medium valve lift amount according to the present invention.

FIG. 5 is a schematic diagram viewed from the arrow A of FIG. 2 illustrating the valve operations in which A indicates the valve closing operation at a time of controlling of a maximum valve lift amount, and B indicates the valve opening operation at a time of controlling of the maximum valve lift amount according to the present invention.

FIG. 6 is a schematic diagram for explaining an operation of a drive mechanism at a time of controlling of the minimum valve lift amount according to the present invention.

FIG. 7 is a planar development view of the drive mechanism.

FIG. 8 is a characteristic view illustrating a relation between a valve lift amount and alternating torque.

FIG. 9 is a flowchart for calculating a rotating angle of a control shaft of the variable valve mechanism as an effective opening of an intake valve.

FIG. 10 is a flowchart for learning a default opening.

FIG. 11 is a flowchart for diagnosing whether or not a default mechanism is in an abnormal state.

FIG. 12 is a flowchart illustrating a changing-over controlling of an intake air amount controlling according to a diagnosis result of the default mechanism.

FIG. 13 is a flowchart illustrating the intake air amount controlling by the variable valve mechanism.

FIG. 14 is a flowchart illustrating a correction control at a time of starting of an engine operation based on a learning result of the default opening.

FIG. 15 is a diagram illustrating a change in driving force characteristics of the variable valve mechanism for a time when the default opening is varied.

### DESCRIPTION OF PREFERRED EMBODIMENTS

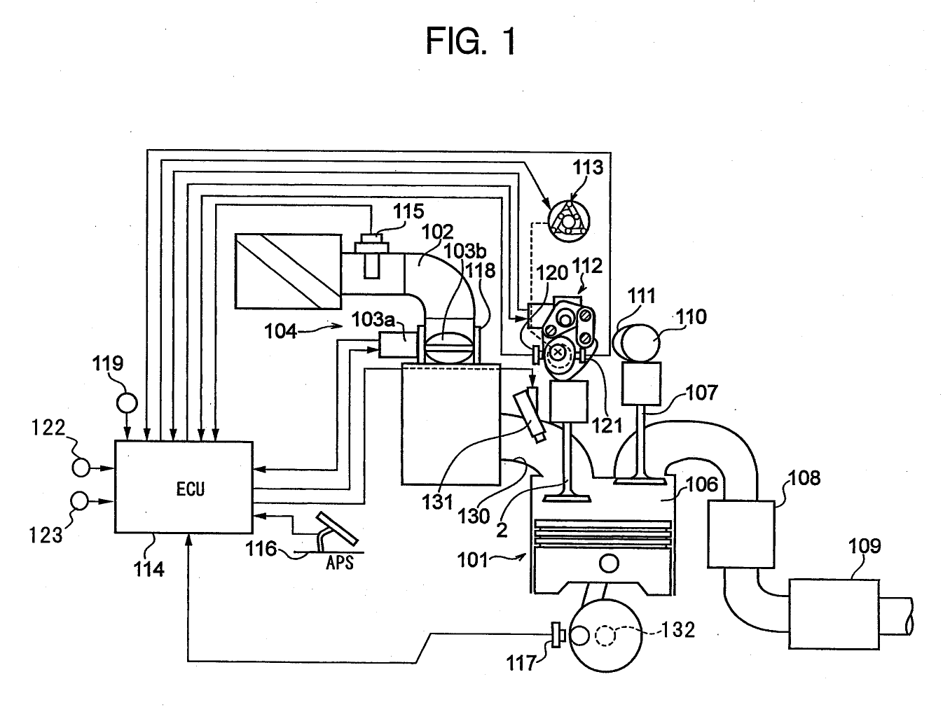

In FIG. 1 illustrating a configuration of an internal combustion engine for vehicle according to the present invention, in an intake pipe 102 of an internal combustion engine 101, there is disposed an electronically controlled throttle 104 which drives to open or close a throttle valve 103b by the use of a throttle motor 103a, and the air is sucked into a combustion chamber 106 via electronically controlled throttle 104 and an intake valve 2.

The combusted exhaust gas is exhausted from combustion chamber 106 via an exhaust valve 107 and thereafter, is purified by a front catalytic converter 108 and a rear catalytic converter 109, to thereby be discharged into the atmosphere.

Exhaust valve 107 is driven to open or close, while maintaining fixed lift amount and operating angle thereof (a crank angle from the opening to the closing) by a cam 111 axially supported by an exhaust camshaft 110.

On the other hand, on the side of intake valve 2, there is disposed a VEL (Variable valve Event and Lift) mechanism 112 which continuously varies a lift amount of intake valve 2 together with an operating angle thereof. Here, if an effective opening is defined as an opening equivalent to an average opening in an intake stroke of intake valve 2, the effective opening is determined based on the valve lift amount and the operating angle. Accordingly, VEL 112 configures a variable valve mechanism which continuously varies the effective opening of intake valve 2.

Similarly, on the side of intake valve 2, VTC (Variable valve Timing Control) mechanisms 113 are disposed on both end portions of intake camshaft 110, each VTC mechanisms 113 is configured by a mechanism which continuously and variably controls a rotating phase difference of an intake camshaft relative to a crankshaft to thereby advance or retard valve timing (valve opening/closing timing) of intake valve 2.

Further, on an intake port 130 of each cylinder, there is disposed an electromagnetic type fuel injection valve 131 which injects fuel adjusted at predetermined pressure toward intake valve 2 when it is driven to open based on an injection pulse signal from an engine control unit (ECU) 114.

ECU 114, into which a microcomputer is incorporated, receives detected signals from various sensors for detecting engine operating state, and performs computation processes based on the detected signals to thereby control electronically controlled throttle 104, VEL mechanism 112, VTC mechanisms 113 and fuel injection valve 131.

As the various sensors described above, there are disposed an air flow meter 115 for detecting an intake air amount Q of engine 101, an accelerator opening sensor APS 116 for detecting an accelerator opening, a crank angle sensor 117 for taking a reference crank angle signal REF (reference rotating position signal) at each crank angle 180° from a crankshaft 132 and a unit angle signal POS at each unit crank angle, a throttle sensor 118 for detecting an opening TVO of throttle valve 103b, a water temperature sensor 119 for detecting the cooling water temperature of engine 101 (or an oil temperature sensor for detecting the lubricating oil temperature), a rotating angle sensor 120 for taking a rotating angle signal of a control shaft 32 (to be described later) of VEL mechanism 112, a cam angle sensor 121 for taking a cam signal CAM (reference rotating position signal) at each cam angle 90° (crank angle 180°) from the intake camshaft, an ignition switch 122 and a starter switch 123.

Incidentally, in ECU 114, an engine rotating speed Ne is calculated based on cycles of the reference crank angle signal REF or the number of the generated unit angle signal POS per unit time.

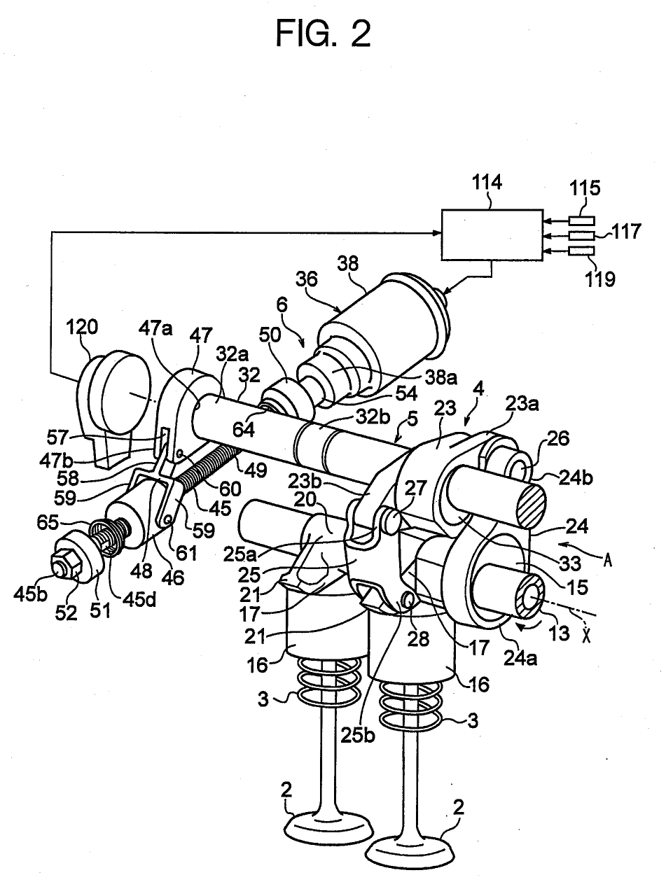

FIGS. 2 through 6 illustrate a structure of VEL mechanism 112 in detail.

Namely, as shown in FIGS. 2 through 5, VEL mechanism 112 comprises: a pair of intake valves 2, 2 slidably disposed on a cylinder head 1 via valve guides (not shown in the figure) to be urged to a valve closing direction by valve springs 3, 3; a variable lift mechanism 4 which variably controls the valve lift amount of each intake valve 2, 2; a control mechanism 5 which controls an operating position of variable lift mechanism 4; and a drive mechanism 6 which drives to rotate control mechanism 5.

Variable lift mechanism 4 comprises: a hollow drive shaft 13 rotatably supported by a bearing 14 disposed on an upper end portion of cylinder head 11, a drive cam 15 being an eccentric rotating cam fixed to drive shaft 13 by press fitting or the like; two swing cams 17, 17 which are swingingly supported on an outer peripheral face of drive shaft 13 and are in contact with valve lifters 16, 16 disposed on upper end portions of intake valves 2, 2 to thereby open intake valves 2, 2; and transmission means connected between drive cam 15 and swing cams 17, 17 for transmitting a rotating force of drive cam 15 as swing forces for swing cams 17, 17.

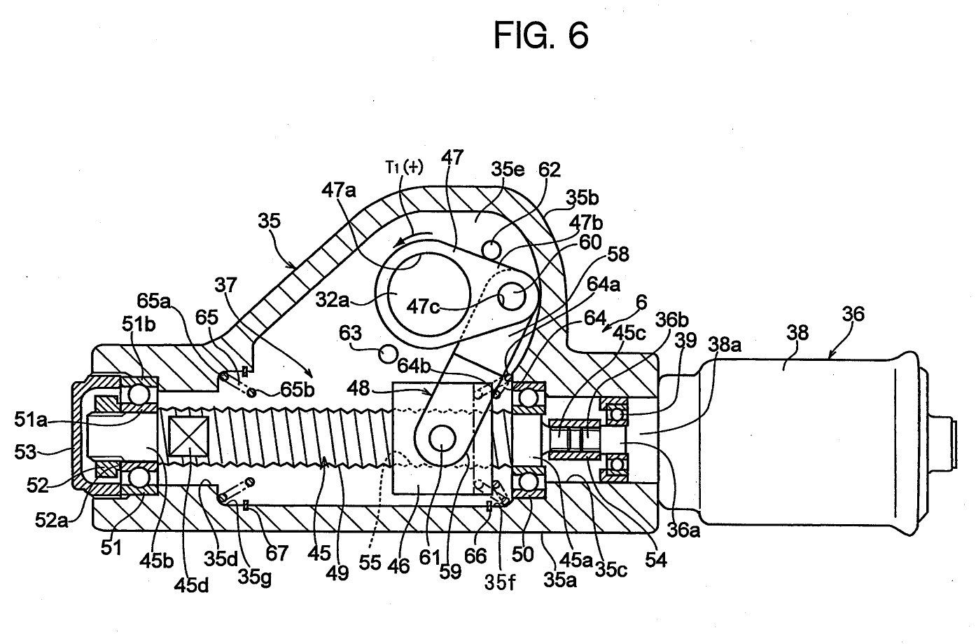

As shown in FIG. 2, drive shaft 13 is arranged along a front-back direction of the engine, and also, is transmitted with a rotating force thereof from the crankshaft of the engine via a follow sprocket (not shown in the figure) disposed on one end portion thereof, a timing chain (not shown in the figure) wounded around the follow sprocket and the like. A direction of this rotating force is set to be in clockwise (an arrow direction) in FIG. 6.

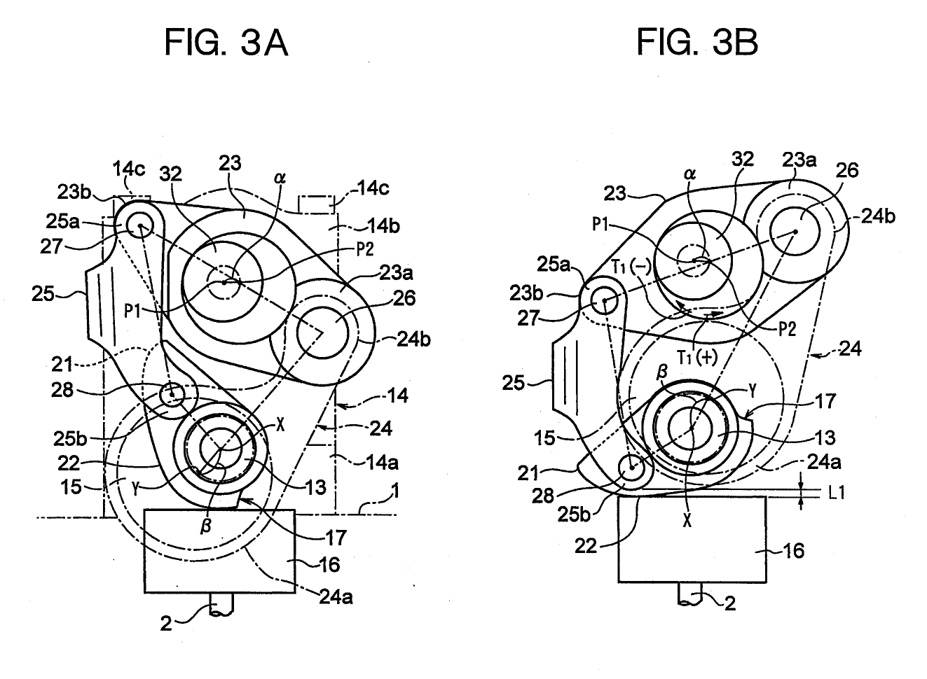

As shown in A of FIG. 3, bearing 14 includes a main bracket 14a disposed on the upper end portion of cylinder head 1 to support an upper portion of drive shaft 13 and a sub bracket 14b disposed on an upper end portion of main bracket 14a to rotatably support a control shaft 32 (to be described later), and brackets 14a and 14b are fastened to be fixed together from above by a pair of bolts 14c, 14c.

Drive cam 15 which is formed in an approximately ring shape, comprises a cam body having a annular shape and a cylindrical portion disposed integrally with an outer end face of the cam body, and a drive shaft insertion hole is formed through in an internal axial direction thereof. Also, a position of an axle center Y of the cam body is biased by a predetermined amount β in a radial direction from a position of an axle center X.

Further, drive cam 15 is pressed and fixed to drive shaft 13 via the drive shaft insertion hole at one outside of drive shaft 13, so as not to interfere with valve lifters 16, 16, and also, an outer peripheral face of the cam body is formed in a cam profile of an eccentric circle.

Each of valve lifters 16, 16 is formed in a cylindrical shape with a lid, and is held slidably in a retention hole of cylinder head 1, and also, upper faces thereof with which swing cams 17, 17 are in contact are formed in flat shape.

As shown in FIG. 2 and FIG. 3, swing cams 17, 17 which are formed in same shape of approximately rain drop shape, are integrally disposed on both end portions of annular camshaft 20, and also, camshaft 20 is rotatably supported by drive shaft 13 via an inner peripheral face thereof.

Further, a pin hole is formed through on the side of a cam nose portion 21 on one end portion of each swing cam 17, and also, on the lower face side of each swing cam 17, a cam face 22 is formed, to thereby form a base circle face on the side of camshaft 20, a ramp face circularly extending from the base circle face to the side of cam nose portion 21 and a lift face connecting from the ramp face to a top face of a maximum lift on the tip end side of cam nose portion 21, so that the base circular face, the ramp face and the lift face are in contact with predetermined positions of an upper face of each valve lifter 16 according to a swing position of each swing cam 17.

As shown in FIG. 2 through FIG. 5, the transmission means comprises a rocker arm 23 arranged above drive shaft 13, a link arm 24 connecting between one end portion 23a of rocker arm 23 and drive cam 15, and a link rod 25 connecting between the other end portion 23b of rocker arm 23 and swing cam 17.

Rocker arm 23 is rotatably supported by control cam 33 (to be described later) via a supporting hole at a central cylindrical base portion thereof. Further, a pin hole, into which a pin 26 is fitted, is formed through one end portion 23a which is formed to protrude from an outer end portion of the cylindrical base portion. Further, a pin hole, into which a pin 27 connected to one end portion 25a of link rod 25 is fitted, is formed through the other end portion 23b which is formed to protrude from an inner end portion of the cylindrical base portion.

Link arm 24 includes an annular-shaped base portion 24a of relatively large diameter and a protrusion end 24b formed to protrude from a predetermined position of an outer peripheral surface of base portion 24a. A fitting hole, with which the cam body of drive cam 15 is rotatably fitted, is formed on a central position of base portion 24a. Also, a pin hole, through which pin 26 is rotatably inserted, is formed through protrusion end 24b.

Link rod 25 is formed in an approximately dog-leg shape with a concave shape at the rocker arm 23 side, and on both end portions 25a and 25b of link rod 25, there are formed pin insertion holes through which end portions of pins 27 and 28 inserted into the respective pin holes on the other end portion 23b of rocker arm 23 and on cam nose portion 21 of swing cam 17 are rotatably inserted.

Snap rings restricting axial transfer of link arm 24 and link rod 25 are disposed on respective end portions of pins 26, 27, 28.

Control mechanism 19 comprises control shaft 32 rotatably supported by bearing 14 on an upper position of drive shaft 13, and a control cam 33 fixed on an outer periphery of control shaft 32 to be slidably fitted into a supporting hole of rocker arm 23, to thereby serve as a swing support of rocker arm 23.

As shown in FIG. 2, control shaft 32 is disposed in front-back direction of the engine in parallel with drive shaft 13, and also, a journal portion 32b thereof at a predetermined position is rotatably borne between main bracket 14a of bearing 14 and sub bracket 14b thereof.

As shown in FIG. 2 through FIG. 5, control cam 33 is in a cylindrical shape, and a position of an axle center P2 thereof is biased by α (by a thick portion) from a position of an axle center P1 of control shaft 32.

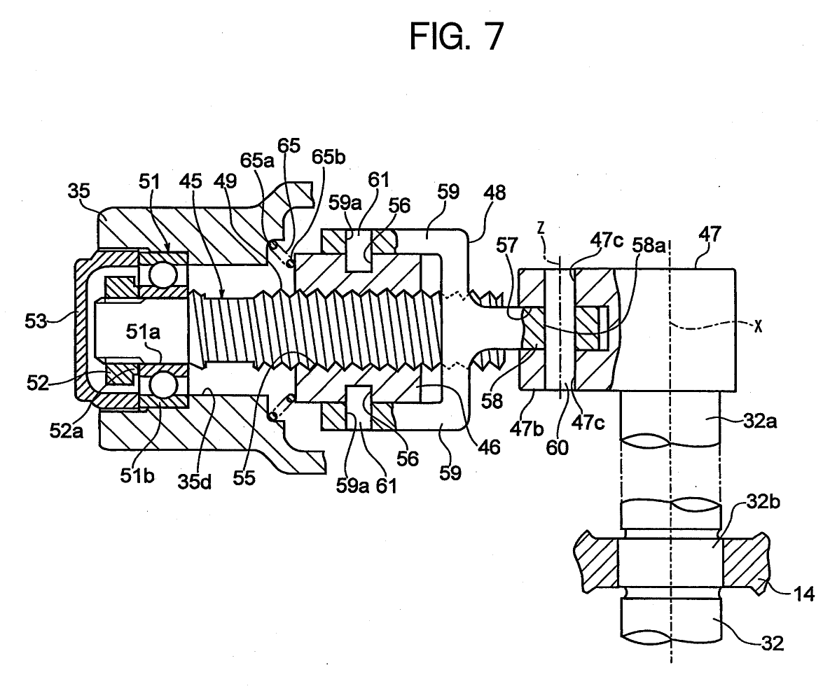

As shown in FIG. 2, and FIG. 6 and FIG. 7, drive mechanism 6 comprises a housing 35 fixed to a rear end portion of cylinder head 1, an electric motor 36 being a rotating force supply mechanism fixed to one end portion of housing 35 and screw transmission means 37 disposed in housing 35 for transmitting a rotation driving force by electric motor 36 to control shaft 32.

Housing 35 comprises a cylinder portion 35a arranged along a direction approximately perpendicular to an axial direction of control shaft 32, an expansion portion 35b formed on the center of an upper end portion of cylinder portion 35a to protrude above, to the interior of which one end portion 32a of control shaft 32 faces, and one end opening portion 35c which blocks up one side portion between cylinder portion 35a and expansion portion 35b.

Electric motor 36 is configured by a proportional type DC motor, and a tip end small diameter portion 38a of an approximately cylindrical motor casing 38 is pressed and fixed to one end opening portion 35c of cylinder portion 35a. Further, a drive shaft 36a of electric motor 36 is borne by ball bearings 39 disposed in tip end small diameter portion 38a of motor casing 38.

Further, electric motor 36 is to be driven based on a control signal output from ECU114, and configures an actuator of VEL mechanism 112.

Here, since the valve lift amount (the effective opening) of intake valve 2 is determined based on a rotating angle of control shaft 32, which is detected by rotating angle sensor 120, rotating angle sensor 120 is the one for detecting the rotating angle of control shaft 32 to thereby detect the effective opening of intake valve 2.

As shown in FIG. 6 and FIG. 7, screw transmission means 37 mainly comprises a screw shaft 45 arranged in cylinder portion 35a of housing 35 approximately coaxially with drive shaft 36a of electric motor 36, a screw nut 46 being a transfer member screwed with an outer periphery of screw shaft 45, a connecting arm 47 being a connecting portion fixed to an outer periphery of one end portion of control shaft 32 in housing 35 and a link member 48 connecting between connecting arm 47 and screw nut 46.

Screw shaft 45 is formed such that external screw portions 49 being screw portions are continuously formed on the entirety of outer peripheral face of screw shaft 45 except for both end portions thereof, and also, both end portions 45a and 45b of the screw shaft, which face to one end opening portion 35c of cylinder portion 35a and the other end opening portion 35d thereof, respectively, are rotatably borne by ball bearings 50 and 51.

Further, to a tip end portion of the other end portion 45b of screw shaft 45, a nut 52 holding screw shaft 45 in cylinder portion 35a is screwed, and according to this nut 52, a protruding portion 52a on one side thereof urges to fix an inner ring 51a of one side ball bearings 51 to a step portion on the side of the other end portion 45b of screw shaft 45, and also, nut 52 is rotated integrally with screw shaft 45. Furthermore, a bawl cap 53 is screwed to the other end opening portion 35d of cylinder portion 35a, so that an outer ring 51b of one side ball bearings 51 is urged to be fixed to a step portion 35h of the other end opening portion 35d by a cylindrical front end portion of cap 53.

Incidentally, on the side of the other end portion 45b of screw shaft 45, there are formed engaging faces 45d, 45d in width of across flat with which a presser jig is engaged, so as to avoid the rotation of screw shaft 45 when nut 52 is fastened by means of a predetermined jig, such as a spanner.

Still further, a tip end small diameter shaft 45c of one end portion 45a in screw shaft 45 and a tip end small diameter portion 36b of drive shaft 36a of electric motor 36 are serration connected by a cylindrical connecting member 54 so as to be coaxially movable in an axial direction.

Namely, serration concave-convex portions are formed on outer peripheral faces of tip end small diameter shaft 45c and of tip end small diameter portion 36b along the axial direction, and on the other hand, a serration portion to be fitted with the serration concave-convex portion in a loose fit state is formed on an inner peripheral face of connecting member 54 along the axial direction. According to such a serration connection, the rotation driving force by electric motor 36 is transmitted to screw shaft 45, and also, the slight movement of screw shaft 45 in the axial direction is permitted.

Screw nut 46 which is formed in an approximately cylindrical shape, on the entirety of inner peripheral face thereof, is formed with an internal screw portion 55 which is screwed with external screw portion 49 to convert the rotating force of screw shaft 45 to a moving force to the axial direction, and also, as shown in FIG. 7, pin holes 56, 56 are formed on both end portions of screw nut 46 on an approximately center position in the axial direction along a diameter direction.

As shown in FIG. 2, connecting arm 47 is formed in an approximately rain-drop shape, and one end portion 32a of control shaft 32 is inserted into a fixing hole 47a formed through a large diameter base portion thereof, and also, connecting arm 47 is fixed to one end portion 32a by means of a bolt (not shown in the figure). Further, a slit 57 is formed on a center position in a width direction of a tapered tip end portion 47b of connecting arm 47, and on tip end portion 47b, two pin holes 47c, 47c continuously running through along control shaft 32 are formed. Accordingly, positions of an axle center Z of pin holes 47c, 47c are biased from a position of axle center P1 of control shaft 32.

Link member 48 which is formed in an approximate Y-shape, comprises one end portion 58 of flat plate shape and the other end portions 59, 59 of two-way shape, and one end portion 58 is arranged to be inserted into slit 57 of connecting arm 47, to be rotatably connected to tip end portion 47b of connecting arm 47 by means of a pin 60 running through pin holes 47c, 47c and a pin hole 58a thereof.

On the other hand, the other end portions 59, 59 of two-way shape are arranged on both sides of screw nut 46 to be rotatably connected to screw nut 46 by means of two pin shafts 61, 61 inserted into pin holes 59a, 59a oppositely formed through and pin holes 56, 56 of screw nut 46. Incidentally, pin 60 is fixed to both pin holes 47c, 47c of screw nut 47 at both end portions thereof, and a center portion thereof is slidable in pin hole 58a of link member 48. On the other hand, pin shafts 61, 61 are pressed and fixed into pin holes 59a, 59a of link member 48 at outer end portions thereof, and inner end portions thereof are slidable in pin holes 56, 56 of screw nut 46.

Further, as shown in FIG. 6, on an inner side of a side wall 35e of housing 35, there are disposed first and second stopper pins 62, 63 being restriction mechanisms which restrict maximum rotating positions in right and left sides of control shaft 32 via connecting arm 47.

Namely, first stopper pin 62 is fixed to a side wall 35e position at which control shaft 32 is rotated in counterclockwise in FIG. 6, so that the valve lift amount of each of intake valves 2, 2 is made minimum by variable lift mechanism 4. On the other hand, second stopper pin 63 is fixed to a side wall 35e position at which control shaft 32 is rotated in clockwise in FIG. 6, so that the valve lift amount is made maximum. Accordingly, the minimum and maximum rotating positions in the right and left sides of control shaft 32 are restricted by first and second stopper pins 62, 63.

Further, step portions 35f, 35g are formed on inner sides of respective opening portions 35c, 35d of housing cylinder portion 35a, respectively, and also, first and second coil springs 64 and 65 being metallic spring members are disposed on step portions 35f, 35g, respectively. Note, in place of these coil springs, wave springs may be used.

Coil springs 64, 65, which are formed in an approximately head-cut conical shape, are in contact with corner portions of step portions 35f, 35g at large diameter portions 64a, 65a thereof, and also, are each slidable in the axial direction via outer peripheral faces of large diameter portions 64a, 65a. Further, as shown in FIG. 6, regarding to each of coil springs 64, 65, small diameter portions 64b, 65b on tip end sides thereof are in contact with front-back end faces of screw nut 46 to impart spring forces to screw nut 46, immediately before connecting arm 47 is rotated to the maximum to the right and left hands to be in contact with first and second stopper pins 62, 63. Accordingly, each of coil springs 64, 65 are spaced from screw nut 46 so as not to impart any spring urging forces, on a normal movement position other than a position in the vicinity of maximum movement of screw nut 46 in the right and left hands. Further, coil springs 64, 65 are dipped in lubricating oil filled in cylinder portion 35a of housing 35.

Furthermore, on inward side positions of step portions 35f, 35g, stopper rings 66, 67 being drop-out prevention mechanisms which restrict inward maximum movements of each coil spring 64, 65 to prevent coil springs 64, 65 from dropping out are fitted to be fixed to an inner periphery of cylinder portion 35a.

In the followings, there will be described operations of the present invention. Firstly, for example, in an engine low rotating operation region including an idle operation time, when a rotating torque transmitted to electric motor 36 based on the control signal output from ECU 114 is transmitted to screw shaft 45 to thereby rotate screw shaft 45, in response to this rotation, screw nut 46 moves to the maximum right hand position as shown in FIG. 6. As a result, control shaft 32 is driven to rotate in counterclockwise by link member 48 and connecting arm 47, and a side face of tip end portion 47b of connecting arm 47 is in contact with first stopper pin 62, so that the further rotation of control shaft 32 is restricted. At the time, one end face of screw nut 46 is pressed to compressively deform small diameter portion 64b of first coil spring 64.

Accordingly, as shown in A and B of FIG. 3, control cam 33 is rotated around the position of the axle center P1 of control shaft 32 in same radius, and the thick portion thereof moves upwards to be spaced from drive shaft 13. As a result, a pivoting point between the other end portion 23b of rocker arm 23 and pivotally support point of link rod 25 moves upwards relative to drive shaft 13, and therefore, each swing cam 17 is forcibly pulled up via link rod 25 at cam nose portion 21 thereof, to be rotated in clockwise as a whole.

Thus, when drive cam 15 is rotated to thereby push up one end portion 23a of locker arm 23 via link arm 24, the valve lift amount at the time is transmitted to swing cam 17 and valve lifter 16 via link rod 25, but a lift amount L1 thereof is sufficiently small.

Accordingly, in such an engine low rotating operation region, the valve lift amount is to be smallest, so that opening timing of each intake valve 2 is retarded and valve overlap with the exhaust valve is to be smaller. Therefore, the fuel consumption can be improved and the stable engine rotation can be achieved.

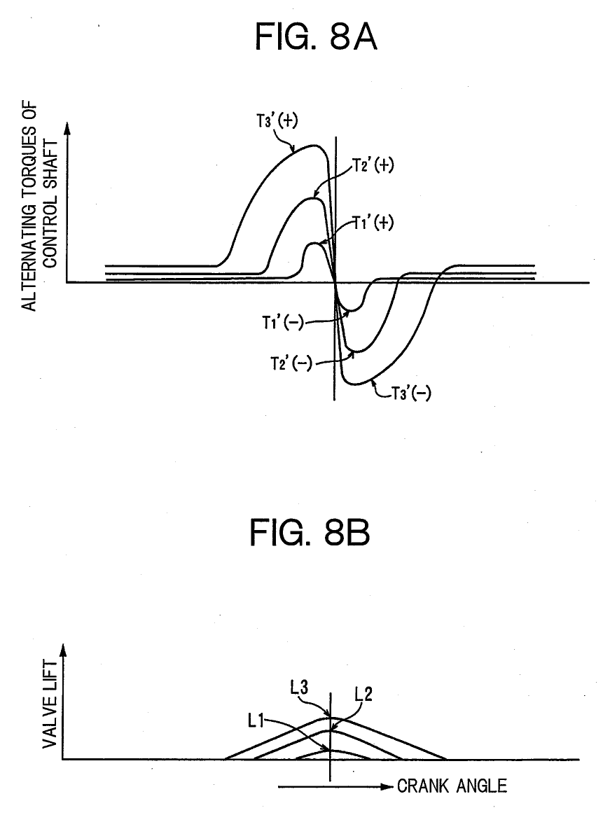

Further, positive and negative (+, −) alternating torques acting on control shaft 32 at this time point are sufficiently small as shown by T1′ in FIG. 8, and accordingly, since a torque load transmitted to screw nut 46 via connecting arm 47 and link member 48 is also small, a large concentrated load on screw shaft 45 does not occur.

Then, immediately before connecting arm 47 is in contact with first stopper pin 62, as shown by a chain line in FIG. 6, small diameter portion 64b of first coil spring 64 is in contact with the one end face of screw nut 46 to impart a spring counterforce thereto. Therefore, a sufficient buffer action of connecting arm 47 to first stopper pin 62 can be obtained, so that the collision of connecting arm 47 with first stopper pin 62 can be reliably avoided.

Further, in the case where the engine rotating operation region is shifted from the low rotating region to a high rotating region due to abrupt acceleration of vehicle from the engine low rotating operation region, when electric motor 36 is reversely rotated based on the control signal output from ECU 114, so that screw shaft 45 is further rotated in the same direction, with this rotation, screw nut 46 largely moves to the left hand in FIG. 6. At the time, connecting arm 48 is restricted from the further movement at a position where connecting arm 48 is in contact with second stopper pin 63, and also, screw nut 46 is also restricted from the further movement, while compressively deforming second coil spring 65.

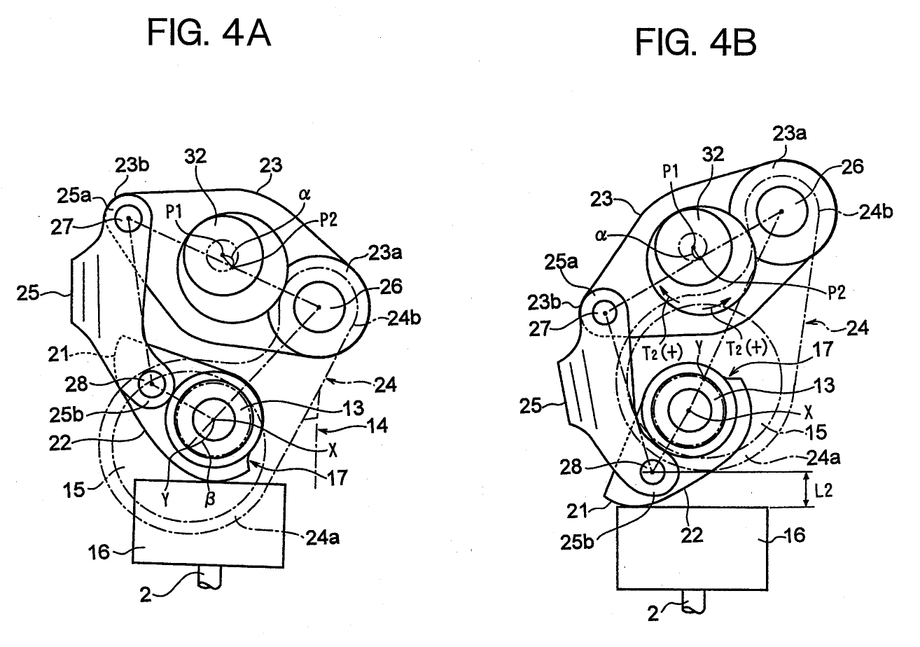

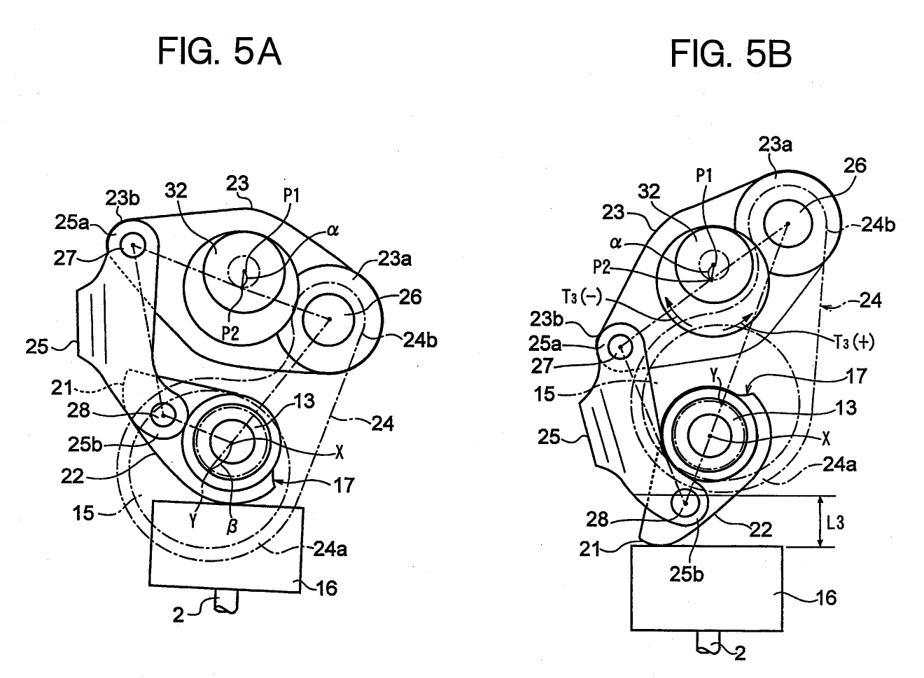

Accordingly, control shaft 32 rotates control cam 33 so as to go through a position shown in FIG. 4 and further rotates control cam 33 in clockwise, so that the position of the axle center P2 is moved downwards as shown in A and B of FIG. 5. Therefore, locker arm 23 moves toward control shaft 13 as a whole, to push cam nose portion 21 of swing cam 17 downwards via link rod 25 by the other end portion 23b thereof, to thereby rotate the entire swing cam 17 in counterclockwise by a predetermined amount.

Accordingly, a contact position of cam face 22 of swing cam 17 to the upper face of valve lifter 16 is moved to a right hand position (lift portion side). Therefore, when drive cam 15 is rotated at an opening operation time of intake valve 2 to thereby push up one end portion 23a of locker arm 23 via link arm 24, so that a lift amount L3 for valve lifter 16 becomes further larger than a medium valve lift amount L2 shown in FIG. 4.

Thus, in such a high rotating operation region, the valve lift amount is increased to the maximum, and the opening timing of each intake valve 2 is advanced while closing timing being delayed. As a result, the intake air filling efficiency is improved and the sufficient power can be ensured.

Further, as shown by T3′ in FIG. 8, the positive and negative (+, −) alternating torques at the time is larger than T1′ at the time of the small valve lift amount or T2′ at the time of the medium valve lift amount.

Furthermore, immediately before connecting arm 47 is in contact with second stopper pin 63, small diameter portion 65b of second coil spring 65 is in contact with the other end face of screw nut 46 to impart the spring counterforce. Therefore, the sufficient buffer action of connecting arm 47 to second stopper pin 63 can be obtained, so that the collision of connecting arm 47 with second stopper pin 63 can be reliably avoided.

Still further, when an ignition key for vehicle is turned OFF to stop the engine operation, there is a possibility that the torque by electric motor 36 does not occur, and control shaft 32 is rotated to one direction to control each intake valve 2 to the smallest valve lift amount via variable lift mechanism 4 based on the alternating torques T1′ immediately before the time of stopping of the engine operation. In such a case, with the rotation of control shaft 32 to the one direction, similarly to the minimum lift control, screw nut 46 is in contact with small diameter portion 64b of first coil spring 64 to receive the spring counterforce, immediately before screw nut 46 linearly moves to the right hand along screw shaft 45 as shown in FIG. 6, and as a result, connecting arm 47 is in contact with first stopper pin 62 to be restricted from the further rotation in the same direction. Therefore, since screw nut 46 is pushed back in a reverse direction (left hand in the figure), connecting arm 47 is not restricted by first stopper pin 62, to be rotated in clockwise. As a result, the valve lift amount is controlled from the small amount to a slightly high amount by variable lift mechanism 4.

Consequently, by a simple structure, such as first and second coil springs 64, 64 and the like, a buffer effect between connecting arm 47 and first and second stopper pins 62, 63 can be obtained.

Further, when the driving of electric motor 36 is stopped, such as the time when the engine operation is stopped, the time when electric motor 36 is failed or the like, a counterforce of valve spring 3 for urging to open intake valve 2 is applied on cam nose portion 21 from valve lifter 16, to decrease the valve lift amount. However, finally, the valve lift amount is held at an amount (default opening: larger than a minimum lift amount) at which the counterforce of valve spring 3 is balanced with the spring force of first coil spring 64.

Namely, present VEL mechanism 112 is provided with a default mechanism which mechanically holds the valve lift amount at the default opening larger than a minimum effective opening.

Accordingly, even at an engine cooling time at which a friction is high and a necessary air-fuel mixture amount is large, the engine operation restarting performance becomes favorable, and at the time when electric motor 36 is failed, a necessary intake air amount can be ensured to thereby achieve a fail-safe performance.

However, in VEL mechanism 112 provided with the default mechanism, due to variations, degradation or the like of spring characteristics of first coil spring 62, the valve lift amount (default opening) in the state where the driving of electric motor 36 is stopped is varied. As a result, the engine operation starting performance and the controllability after the engine operation start and the fail-safe performance at the failure time are influenced by the variations in the valve lift amount.

Therefore, as a configuration of one embodiment according to the present invention, a control is performed such that the default opening is detected; the detected default opening is learned; a fuel injection amount or ignition timing is corrected based on the detected or learned default opening; and when the detected or learned default opening is abnormal, the abnormality is warned.

In the followings, there will be described the learning of the default opening and the control based on the learning result.

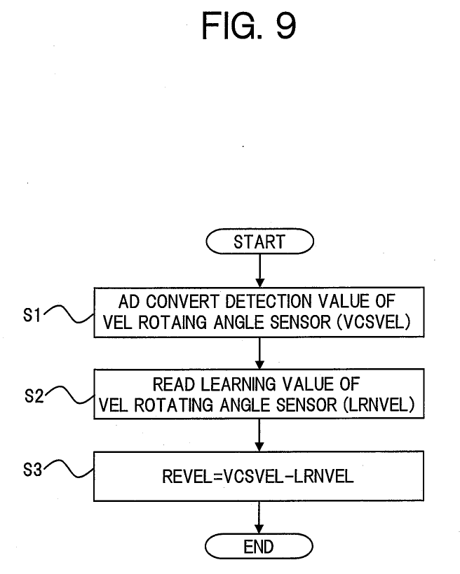

FIG. 9 shows a flowchart of calculating a real rotating angle REVEL of control shaft 32 as the effective opening of intake valve 2.

In step S1, a detection value (analog value) by rotating angle sensor 120 is A/D converted, to thereby calculate VCSVEL.

In step S2, a learning value LRNVEL in a learning of minimum rotating angle of rotating angle sensor 120, which is executed in a routine (not shown in the figure), is read. This minimum rotating angle learning is executed specifically by updating to store, as the learning value LRNVEL, the rotating angle of control shaft 32 at the minimum valve lift amount time for when connecting arm 47 is in contact with first stopper pin 62 under a predetermined condition.

In step S3, the real rotating angle REVEL of control shaft 32 is calculated by subtracting the learning value LRNVEL from the detection value VCSVEL as in the next formula.

REVEL=VCSVEL−LRNVEL

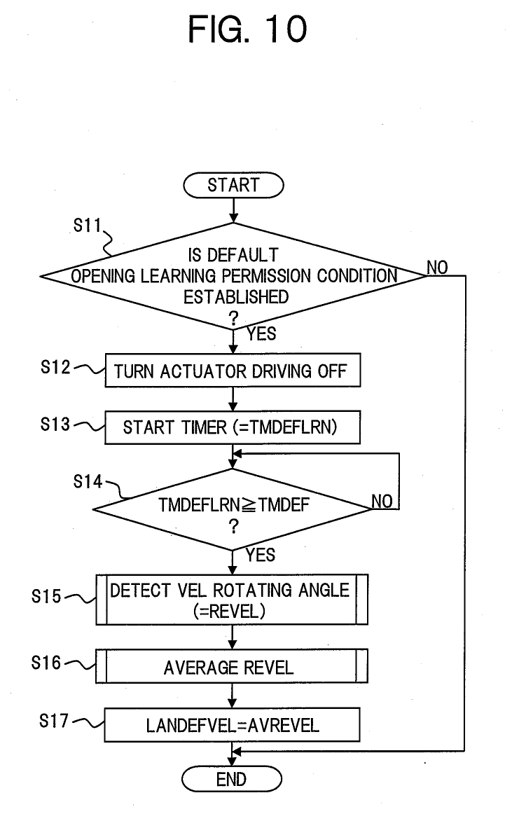

FIG. 10 shows a flowchart of learning the default opening.

In step S11, it is judged whether or not a default opening learning permission condition by the default mechanism is established. The learning permission condition is established when any one of the following conditions, for example, is satisfied.
a. Ignition switch 122 is OFF.
b. Starter switch 123 is ON.
c. Fuel is in a cut off state.
d. a time when it is judged that the engine is stalled.

Namely, when any one of the above conditions is satisfied, the condition is such that, even if the valve lift amount is controlled at the default opening by the default mechanism, such a control does not affect the engine operation or the engine operation is stopped. However, regarding the time of starting of the engine operation (a time of engine cranking) in the condition (b), a control further suitable for the engine operation starting performance is performed as described later.

If it is judged in step S11 that the default opening learning permission condition is established, in step S12 and the subsequent steps, the valve lift amount of intake valve 2 is controlled at the default opening by the default mechanism, and the default opening is learned.

In step S12, the power supply to electric motor 36 being the actuator for VEL mechanism 112 is turned OFF, to stop the driving of electric motor 36. As a result, when the valve lift amount is larger or smaller than the default opening before the power supply OFF except for the condition (b), as described above, control shaft 32 is rotated until the valve lift amount reaches the default opening at which the counterforce of return spring of intake valve 2 is balanced with the spring force of first coil spring 64.

Considering that it takes a time at a certain degree until the valve lift amount reaches the default opening, in step S13, a timer TMDEFLRN for measuring an elapsed time after the power supply stop is activated (the counting is started).

In step S14, it is judged whether or not a count value TMDEFLRN of the timer reaches a predetermined value TMDEF, and if it is judged that the count value TMDEFLR reaches the predetermined value TMDEF, it is judged that the valve lift amount reaches the default opening, and the routine proceeds to step S15.

In step S15, the rotating angle REVEL of control shaft 32 of VEL mechanism 112 is detected, as the default opening of intake valve 2, at each constant time for predetermined number of times, in accordance with the flowchart shown in FIG. 9.

In step S16, the rotating angles REVEL for the predetermined number of times detected in step S15 are averaged.

In step S17, an average value AVREVEL of the rotating angle REVEL is stored to be updated as a learning value LRNDEFVEL of the default opening.

Incidentally, in the case where the intake air amount necessary for starting of the engine operation is hard to be ensured by the default opening when the learning of the default opening is executed at the time of starting of the engine operation in the condition (b), a throttle opening can be correctively increased by electronically controlled throttle 104 to compensate for shortage of intake air.

Various controls are performed using the learning value LRNDEFVEL of the default opening obtained in the above manner.

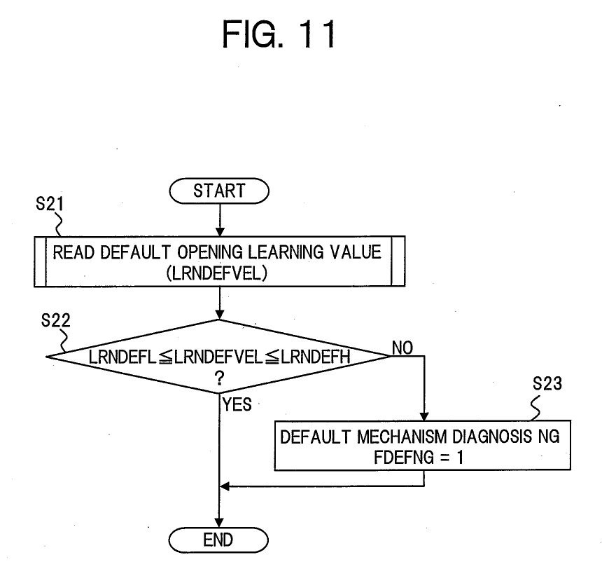

FIG. 11 shows a flowchart of diagnosing whether or not the default mechanism is in an abnormal state.

In step S21, the learning value LRNDEFVEL of the default opening is read.

In step S22, it is judged whether or not the learning value LRNDEFVEL is in a normal range equal to or larger than a lower limit value LRNDEFL for abnormality judgment but equal to or smaller than an upper limit value LRNDEFH for abnormality judgment, and if the learning value LRNDEFVEL is outside the normal range, it is diagnosed that the default mechanism is in the abnormal state, and the routine proceeds to step S23 where an abnormality flag EDEFNG is set at 1, and also, a warning is performed by turning a warning light ON or the like. Thus, it is possible to cope with the abnormality in the default mechanism by storing the judgment result and performing the warning.

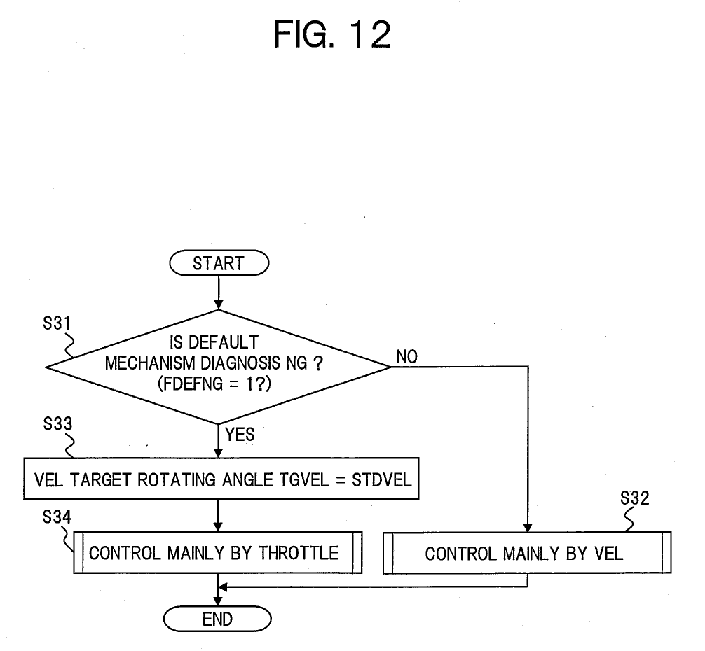

FIG. 12 shows a flowchart of changing-over of intake air amount controlling according to the diagnosis result of the default mechanism.

In step S31, it is judged whether or not the default mechanism is diagnosed to be in the abnormal state in the above diagnosis, based on whether or not the abnormality flag FDEFNG is set at 1.

When it is judged that the default mechanism is in a normal state, the routine proceeds to step S32 where the intake air amount control is performed mainly by VEL mechanism 112. To be specific, by a throttle opening controlling using electronically controlled throttle 104, VEL mechanism 112 is controlled so that a target intake air amount equivalent to a target torque set based on the engine operating conditions is obtained while controlling the downstream side of the throttle at the intake pressure according to the engine operating state, to thereby control the valve lift amount (the effective opening) of intake valve 2.

On the other hand, when it is judged that the default mechanism is in the abnormal state, the routine proceeds to step S33 where a target valve lift amount (target effective opening) of intake valve 2 by VEL mechanism 112, that is, a target rotating angle of control shaft 32, is set at a reference value STDVEL, to thereby fix the valve lift amount of intake valve 2 at a predetermined value.

In step S34, electronically controlled throttle 104 controls the throttle opening so as to obtain the target intake air amount equivalent to the target torque.

Incidentally, the reference value STDVEL may set at a value by which the maximum valve lift amount or the valve lift amount closer thereto can be obtained, to thereby throttle control the intake air amount by the throttle control upon request.

Thus, the default mechanism is diagnosed, and when the default mechanism is in the normal state, the optimum intake air amount controlling of favorable response characteristic and favorable fuel consumption can be performed by VEL mechanism 112. Also, even if the default mechanism is diagnosed to be in the abnormal state, the intake air amount controlling can be changed-over to that mainly by electronically controlled throttle 104 to continue the engine operation satisfying the target torque without any problem.

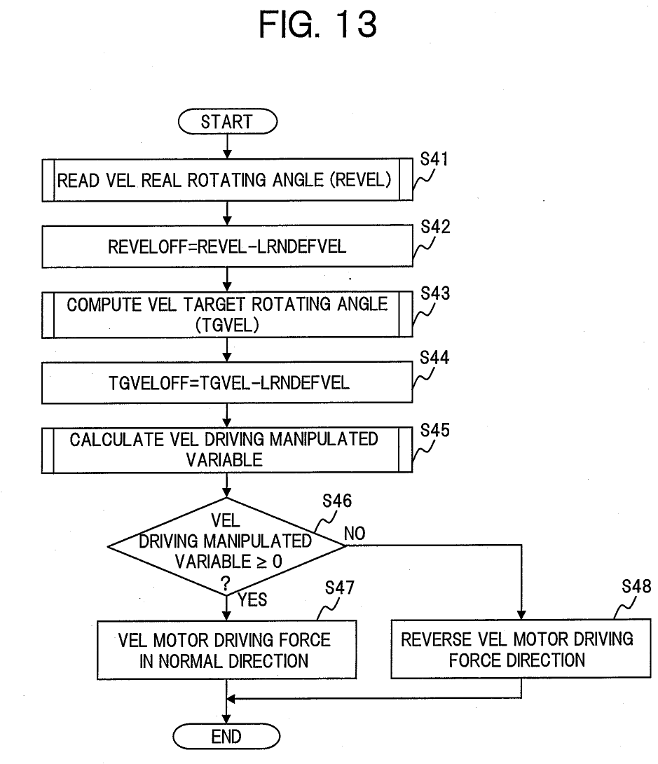

FIG. 13 shows a flowchart of intake air amount control by VEL mechanism 112.

In step S41, the real rotating angle REVEL of VEL mechanism 112 (rotating angle of control shaft 32), which is detected in FIG. 9, is read.

In step S42, the learning value LRNDEFVEL of the default opening is subtracted from the real rotating angle REVEL, to calculate a post-offset real rotating angle REVELOFF which is offset by a learning value portion. In order to perform the drive control using the default opening LRNDEFVEL after the learning as a reference 0 point, the real rotating angle from the reference 0 point is calculated.

In step S43, a target rotating angle TGVEL of VEL mechanism 112 set based on the engine operating state is calculated.

In step S44, the learning value LRNDEFVEL of the default opening is subtracted from the target rotating angle TGVEL, to calculate a post-offset target rotating angle TGVELOFF which is offset by a learning value portion. Similarly to the explanation in step S42, in order to perform the drive control using the default opening LRNDEFVEL after the learning as a reference 0 point, the target rotating angle from the reference 0 point is calculated.

In step S45, a driving manipulated variable for VEL mechanism 112 (the power supply amount for electric motor 36) is calculated based on the post-offset target rotating angle TGVELOFF and the post-offset real rotating angle REVELOFF.

In step S46, it is judged whether or not the driving manipulated variable is equal to or larger than 0. When it is judged that the driving manipulated variable is equal to or larger than 0, the routine proceeds to step S47 where a driving force in a normal rotating direction is supplied to electric motor 36.

When the driving force in the normal rotating direction is increased, control shaft 32 is rotated in clockwise in FIG. 6 and the like, against the counterforce from valve spring 3 of intake valve 2, and screw nut 46 moves to the left hand in FIG. 6, so that the valve lift amount (effective opening) of intake valve 2 is increased.

On the other hand, when the driving force in the normal rotating direction is decreased, control shaft 32 is rotated in the reverse direction by the counterforce from valve spring 3, and screw nut 46 moves to the right hand in FIG. 6 to be returned to the position at which the counterforce of valve spring 3 is balanced with the counterforce of first coil spring 64, so that the valve lift amount (effective opening) of intake valve 2 is decreased to reach the default opening.

On the other hand, when it is judged in step S47 that the driving manipulated variable is smaller than 0, the routine proceeds to step S48 where the driving force in a reverse rotating direction is supplied to electric motor 36.

When the driving force in the reverse rotating direction is increased, control shaft 32 is rotated in a direction reverse to that in the normal rotation, and screw nut 46 moves to the right hand in FIG. 6 against the urging force of first coil spring 64, so that the valve lift amount (effective opening) of intake valve 2 is decreased to be smaller than the default opening.

On the other hand, when the driving force in the reverse rotating direction is decreased, control shaft 32 is rotated in the normal rotating direction, and screw nut 46 moves to the left hand in FIG. 6, against the urging force of first coil spring 64 to be returned to the position at which the counterforce of valve spring 3 is balanced with the spring force of first coil spring 64, so that the valve lift amount (effective opening) of intake valve 2 is increased to reach the default opening.

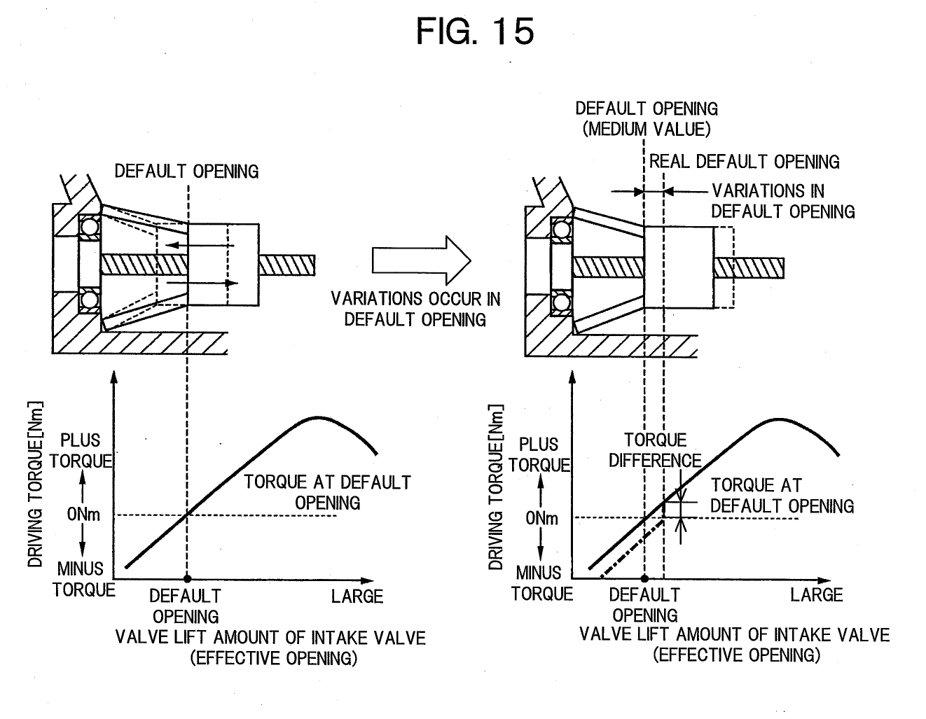

An operation of the intake air amount controlling by VEL mechanism 112 using the above learning value LRNDEFVEL will be described in accordance with FIG. 15. For example, in a state shown on the left side in the figure where the default opening is held at the reference opening (initial position), when the default opening is increasingly varied to be larger than the reference opening as shown by a chain line on the right side in the figure, properties of the driving force of electric motor 36 of VEL mechanism 112 are changed, so that a torque difference occurs in the vicinity of real default opening.

Here, if the system is such that the learning of the default opening is not performed and a direction of driving force is switched from default opening which is equal to reference opening, since a driving direction is switched when the effective opening (valve lift amount) of intake valve 2 is increased to be larger than the reference opening, the driving force becomes excessive to occur overshooting or hunting, so that the effective opening (valve lift amount) of intake valve 2 is hard to be stabilized at the target effective opening.

Further, even if the driving force to the normal direction is decreased to reach 0 when the effective opening (valve lift amount) is decreased so as to be smaller than the real default opening, the effective opening is decreased only to the real default opening. If the driving force is switched by a feedback control, the effective opening (valve lift amount) can be finally converged to the target effective opening, but resulting in a large delay.

In the embodiment of the present invention, the configuration is such that even if the default opening is varied, the real default opening is learned, and the driving force direction is switched around the learning value LRNDEFVEL being the real default opening. Therefore, without the necessity of supplying the excessive driving force or without the delay in switching the necessary driving force, the proper driving force can be promptly supplied, so that the control of high precision can be maintained.

The above description is for improving the variations in the default opening after the time of starting of the engine operation. However, if the default opening is varied, such variations influence on the exhaust purifying function of the engine or the operating performance at the time of starting of the engine operation, and therefore, a correction for avoiding such an influence is performed.

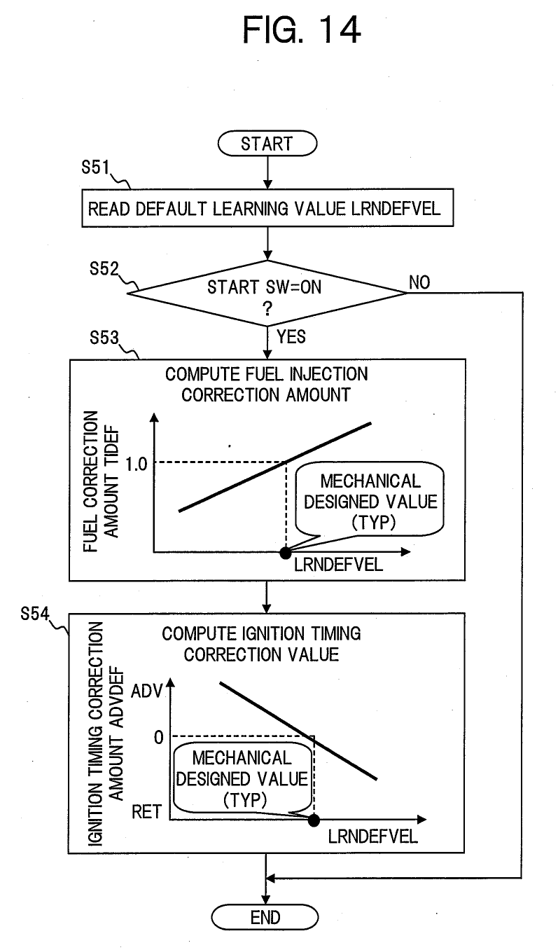

FIG. 14 shows a flowchart of correction controlling at the time of starting of the engine operation.

In step S51, the learning value LRNDEFVEL of the default opening is read.

In step S52, it is judged whether or not starter switch 123 is ON.

When it is judged that starter switch 123 is ON (the time of starting of the engine operation (the time of engine cranking)), the routine proceeds to step S53 where a correction amount TIDEF of the fuel injection amount is calculated based on the learning value LRNDEFVEL. To be specific, as shown in the figure, as the learning value LRNDEFVEL is smaller than the reference opening (designed value), the default opening (effective opening) of intake valve 2 is small and the intake air amount is smaller than a reference value. Therefore, a correctively decreasing amount of the fuel injection amount is increased (a decreasing amount from 1.0 is increased). As the learning value LRNDEFVEL is larger than the reference opening, the intake air amount is larger than the reference value. Therefore, an correctively increasing amount of the fuel injection amount is increased (an increasing amount from 1.0 is increased).

Thus, it is possible to correct the fuel injection amount to be appropriate for the intake air amount, so that an air-fuel ratio can be maintained at an air-fuel ratio for starting of engine operation, thereby favorably maintaining the exhaust purifying function of the engine.

Next, in step S54, a correction amount ADDEF of ignition timing is calculated based on the learning value LRNDEFVEL. To be specific, as shown in the figure, an advance angle correction amount of ignition timing is increased as the learning value LRNDEFVEL is smaller than the reference opening (designed value), whereas a retarded angle correction amount of ignition timing is increased as the learning value LRNDEFVEL is larger than the reference opening.

Thus, when the default opening is varied to be increased, an increase of torque with the increase of intake air amount and the increase of corrected fuel injection amount can be suppressed by the retarding correction of ignition timing. When the default opening is varied to be decreased, a decrease of torque with the decrease of intake air amount and the decrease of corrected fuel injection amount can be suppressed by the advancing correction of ignition timing. Namely, the driving force supplying direction can always be switched at an optimum point, independently of the variations in the default opening.

Consequently, at the time of starting of the engine operation at which the intake air amount cannot be measured by the air flow meter, the necessary and sufficient torque can be ensured, and the favorable engine operation starting performance and the favorable fuel consumption performance can be obtained.

The entire contents of Japanese Patent Application No. 2007-251259 filed on Sep. 27, 2007, a priority of which is claimed, are incorporated herein by reference.

While only selected embodiment has been chosen to illustrate and describe the present invention, it will be apparent to those skilled in the art from this disclosure that various changes and modifications can be made herein without departing from the scope of the invention as defined in the appended claims.

Furthermore, the foregoing description of the embodiment according to the present invention is provided for illustration only, and not for the purpose of limiting the invention as defined by the appended claims and their equivalents.

We claim:

1. An apparatus for controlling a variable valve mechanism capable of continuously varying an effective opening of an engine valve provided for an engine, comprising:
an actuator configured to drive the variable valve mechanism;
a default mechanism provided to be incorporated in the variable valve mechanism to mechanically hold the engine valve at a default opening set to be larger than a minimum effective opening at a time when the driving of the actuator is stopped;
a valve opening detector configured to detect the effective opening of the engine valve; and
a control unit including a default opening learning section that learns the default opening, based on the effective opening of the engine valve detected by the valve opening detector while the engine valve is being held at the default opening by the default mechanism.

2. The apparatus according to claim 1, further comprising;
an operating state detector configured to detect engine operating state of the engine,
wherein the control unit further comprises;
a predetermined operating state judging section that judges whether or not the engine stays at a predetermined engine operating state in which, irrespective of holding of the engine valve at the default opening by the default mechanism, any influence from the engine valve on the engine operability can be neglected, and
wherein the default opening learning section is capable of stopping the driving of the actuator when it is judged that the engine stays at the predetermined engine operating state thereby holding the engine valve at the default opening thereof to implement learning of the default opening.

3. The apparatus according to claim 2, wherein the predetermined engine operating state of the engine is an operating state where an exhaust purifying function of the engine is maintained at a good performance level when the engine valve is held at the default opening thereof.

4. The apparatus according to claim 2, wherein the predetermined engine operating state of the engine is a state selected from a time of starting of the engine operation, a time of stopping of the engine operation, and a time of cutting off of fuel supply.

5. The apparatus according to claim 4, wherein the control unit further comprises;
a throttle opening correcting section configured to correctively increase an opening of a throttle valve disposed in an intake system to compensate for shortage of intake air at the default opening of the engine valve relative to a required amount of the intake air, when the learning is performed by the default opening learning section at the time of starting of the engine operation.

6. The apparatus according to claim 1, wherein the control unit further comprises;
a parameter characteristics correcting section configured to correct characteristics of engine control parameters which depend on the effective opening of the engine valve, based on a result of the learning of the default opening by the default opening learning section.

7. The apparatus according to claim 6, wherein the parameter characteristics correcting section correctively increases a fuel injection amount and corrects ignition timing toward a retarded angle side, when the default opening of the engine valve is deviated to increase with respect to a reference opening thereof, and on the other hand, correctively decrease the fuel injection amount and corrects the ignition timing toward an advance angle side, when the default opening of the engine valve is deviated to decrease with respect to the reference opening.

8. The apparatus according to claim 1, wherein the control unit further comprises;
a default mechanism diagnosing section configured to judge the default mechanism to be in an abnormal state, when the default opening of the engine valve learned by the default opening learning section comes outside a predetermined region for implementing judgment as to whether or not the default mechanism is in the abnormal state.

9. The apparatus according to claim 8, wherein the default mechanism diagnosing section stores, when the judgment indicates that the default mechanism is in the abnormal state, a result of the judgment and implements a warning.

10. The apparatus according to claim 8, wherein the control unit further comprises;
a control changing-over section configured to changes-over control of an intake air amount achieved by mainly a throttle valve disposed in an intake system from that achieved by mainly the variable valve mechanism, when the default mechanism diagnosing section judges that the default mechanism is in the abnormal state.

11. The apparatus according to claim 10, wherein the control changing-over section controls the throttle valve so that an intake pressure is kept at a target intake pressure that is set according to the engine operating state of the engine, when the default mechanism diagnosing section judges that the default mechanism is in a normal state.

12. The apparatus according to claim 1, wherein the control unit further comprises;
an actuator controlling and correcting section configured to switch a direction of supply of a driving force by the actuator between an increase-direction causing an increase in the effective opening and a decrease-direction causing a decrease therein, from the learned default opening of the engine valve.

13. An apparatus for controlling a variable valve mechanism capable of continuously varying an effective opening of an engine valve of an engine, comprising:
an actuator configured to drive the variable valve mechanism;
a default mechanism provided to be incorporated in the variable valve mechanism, which mechanically holds the engine valve at a default opening that is set to be larger than a minimum effective opening of the engine valve at a time when driving of the actuator is stopped; and
control unit comprising:
a default mechanism diagnosing section that judges whether or not the default mechanism is in an abnormal state; and
a control changing-over section that implements an intake air amount controlling by mainly the variable valve mechanism when the default mechanism diagnosing section judges that the default mechanism is in a normal state, and also changes-over the intake air amount controlling to that by mainly an electronically controlled throttle when the default mechanism diagnosing section judges that the default mechanism is in an abnormal state.

14. An apparatus for controlling a variable valve mechanism capable of continuously varying an effective opening of an engine valve of an engine, comprising:
an actuator configured to drive the variable valve mechanism;
a default mechanism provided to be incorporated in the variable valve mechanism, which mechanically holds the engine valve at a default opening that is set to be larger than a minimum effective opening of the engine valve at a time when driving of the actuator is stopped; and
a control unit comprising:
a default opening detecting section that detects the default opening of the engine valve, based on the effective opening detected by the valve opening detector in a state where the effective opening is held at the default opening by the default mechanism; and
a parameter characteristics correcting section that correctively increases a fuel injection amount and/or corrects ignition timing toward a retarded angle side, when the default opening is deviated to increase relative to a reference opening of the engine valve, and on the other hand, correctively decreases the fuel injection amount and/or corrects the ignition timing toward an advance angle side, when the default opening of the engine valve is deviated to decrease relative to the reference opening of the engine valve.

15. An apparatus for controlling a variable valve mechanism capable of continuously varying an effective opening of an engine valve of an engine, comprising:
an actuator configured to drive the variable valve mechanism;
a default mechanism provided to be incorporated in the variable valve mechanism, which mechanically holds the engine valve at a default opening that is set to be larger than a minimum effective opening of the engine valve at a time when driving of the actuator is stopped;
valve opening detecting means for detecting the effective opening of the engine valve; and
default opening learning means for learning the default opening, based on the effective opening of the engine valve detected by the valve opening detecting means.

16. A method of controlling a variable valve mechanism capable of continuously varying an effective opening of an engine valve of an internal combustion engine, the method comprising the steps of:
driving the variable valve mechanism by an actuator while mechanically holding the engine valve at a default opening that is set to be larger than a minimum effective opening of the engine valve by a default mechanism, at a time when driving of the actuator is stopped;
detecting the effective opening of the engine valve in a state where the engine valve is held at the default opening by the default mechanism; and
learning the default opening, based on the effective opening of the engine valve detected while the engine valve is being held at the default opening thereof.

17. The method according to claim 16, further comprising the steps of:
detecting engine operating state; and
judging whether the engine operating state is a state selected from a time of starting of an engine operation, a time of stopping of the engine operation, or a time of cutting off fuel supply, wherein when it is judged that the engine operating state is any one thereof, the driving of the actuator is stopped and the engine valve is held at the default opening to thereby learn the default opening.

18. The method according to claim 16, further comprising the step of;
correctively increasing an opening of a throttle valve disposed in an intake system to correct shortage of intake air in the default opening relative to a required intake air amount, when the learning is implemented by the default opening learning step at the time of starting of the engine operation.

19. The method according to claim 16, further comprising the step of;
correctively increasing a fuel injection amount and correcting ignition timing toward a retarded angle side thereof, when the default opening is deviated to increase relative to a reference opening of the engine valve, and while, correctively decreasing the fuel injection amount and correcting the ignition timing toward an advance angle side, when the default opening is deviated to decrease relative to the reference opening, based on a result of the learning of the default opening of the engine valve by the step of learning the default opening.

20. The method according to claim 16, further comprising the steps of:
judging, when the default opening learned by the learning step is outside a predetermined region for judgment of the abnormal state of the default mechanism, that the default mechanism is in an abnormal state; and
changing-over control of an intake air amount by mainly a throttle valve disposed in an intake system from that by mainly the variable valve mechanism, when the judgment indicates that the default mechanism is in the abnormal state.
